(19) United States
(12) Patent Application Publication
(10) Pub. No.: US 2025/0375344 A1
(43) Pub. Date: Dec. 11, 2025

(54) CYLINDRICAL HEALTH DEVICE AND METHOD FOR MANUFACTURING CYLINDRICAL HEALTH DEVICE

(71) Applicant: JUTE inc., Tokyo (JP)

(72) Inventor: Shigeo MORIDAIRA, Tokyo (JP)

(21) Appl. No.: 19/227,457

(22) Filed: Jun. 4, 2025

(30) Foreign Application Priority Data
Jun. 7, 2024 (JP) 2024-093296

(51) Int. Cl. A61H 15/00

(52) U.S. Cl. CPC A61H 15/0092; A61H 2015/0014; A61H 2201/1654; A61H 2201/1695

(57) ABSTRACT

A cylindrical health device includes, from an inside toward an outside, at least a cylindrical member and a treatment portion. The treatment portion is made of a foamed resin, and a reinforcing member having a plate shape is provided at least at a central portion of the cylindrical member along a longitudinal direction. Furthermore, the cylindrical member is a thin-walled cylindrical object having an internal space of a predetermined volume, and maintains lightweight while allowing an inside of the cylindrical member to be used for various purposes. In addition, typically, the shape of the reinforcing member is a plate shape such that the reinforcing member is easily accommodated inside the cylindrical member of the cylindrical health device.

### CROSS-REFERENCE TO RELATED APPLICATIONS

This patent specification is based on Japanese patent application, No. 2024-093296 filed on Jun. 7, 2024 in the Japan Patent Office, the entire contents of which are incorporated by reference herein.

### TECHNICAL FIELD

The present invention relates to a cylindrical health device (hereinafter, may be referred to as a foam roller) that is lightweight, has good mechanical strength, durability, or the like, and could effectively relieve adhesions or the like in the human fascia, and a method for manufacturing such a cylindrical health device.

### BACKGROUND ART

Conventionally, various manual massage devices have been proposed for relieving tension or adhesions in muscles or tendons and surrounding tissues such as fascia in the human body and for reducing pain and fatigue.

However, various manual massage devices are often mainly used to perform treatment by pressing an affected part, and could not provide sufficient effects in an area that is difficult to reach by hand, such as the back, or an area to which it is difficult to apply a weight load or load.

Furthermore, there has also been a problem in that due to inappropriate massage intensity, further muscle damage or the like may occur depending on the condition of muscles of a subject.

Therefore, a massage roller that is effective in relieving discord between muscles and their connective tissues even in an area that is difficult to reach by hand, such as the back, and that could also be used for core training and the like has been proposed (for example, refer to U.S. Pat. No. 9,005,146).

More specifically, as shown in FIG. 10, a massage roller 100 is composed of a roller core 112 disposed inside, and an elastic body 113 provided around the roller core 112 and constituting a surface layer.

Furthermore, the elastic body 113 has a plurality of massage zones 113a, 113b, and 113c having different densities.

### SUMMARY OF THE INVENTION

### Problem to be Solved by the Invention

However, in the massage roller 100 disclosed in U.S. Pat. No. 9,005,146, the elastic body 113 having the plurality of massage zones 113a, 113b, and 113c having different densities is formed around the roller core 112. For this reason, there has been a problem in that, in order to increase the mechanical strength or durability of the roller core 112, the roller core 112 must be made relatively thick, thereby increasing the weight.

In addition, since it is necessary to form the plurality of massage zones 113a, 113b, and 113c having different densities, there has also been a problem in that not only is considerable manufacturing management required, but stable manufacturing is also difficult and the manufacturing time or manufacturing costs is likely to increase.

Moreover, since the fixation between the roller core 112 and the elastic body 113 having the plurality of massage zones 113a, 113b, and 113c having different densities is not sufficient, there has also been a problem in that, during treatment, the elastic body 113 peels off from the roller core 112, as a result of which misalignment is likely to occur.

As a result of intensive research, the inventors have discovered that, by configuring a cylindrical health device to include a reinforcing member having a predetermined shape at a predetermined location, even when the weight of the cylindrical health device is reduced, the cylindrical health device is enabled to withstand a considerable weight without providing a plurality of massage zones having different densities on a surface layer, and therefore, the cylindrical health device could be stably manufactured and could effectively exhibit a predetermined treatment effect, and have completed the invention.

Namely, an object of the invention is to provide a cylindrical health device that not only has lightweight, good durability, or the like, but also could easily relieve adhesions or tension in fascia, muscles, or the like through a predetermined treatment, and an efficient manufacturing method of the same.

### Means for Solving Problem

According to the invention, the above-described problems could be solved by providing a cylindrical health device including, from an inside toward an outside, at least a cylindrical member; an adhesive layer; and a treatment portion, in which the treatment portion is made of a foamed resin, and a reinforcing member is provided at least at a central portion of the cylindrical member along a longitudinal direction.

Namely, by providing the reinforcing member at a predetermined location of the cylindrical member, the cylindrical health device is enabled to withstand a considerable weight while maintaining lightweight, and therefore, when the cylindrical health device is used for a predetermined treatment, the treatment portion made of a foamed resin on the surface could effectively induce recovery from adhesions, tension, or the like in human fascia, muscles, or the like.

In addition, in configuring the cylindrical health device of the invention, it is preferable that the reinforcing member has a plate shape and is provided with an opening.

The opening ratio could be appropriately adjusted by providing at least one opening in the reinforcing member having a plate shape in this way, thereby achieving lightweight or thinning while maintaining the strength of the reinforcing member.

Therefore, even when the reinforcing member having a plate shape and including the opening is provided, the reinforcing member could significantly contribute to improving mechanical strength while substantially maintaining the lightweight of the cylindrical health device.

In addition, in configuring the cylindrical health device of the invention, it is preferable that the reinforcing member is fixed to a fixing portion provided in the cylindrical member.

Namely, by providing a groove, a projection, a predetermined wall, or the like as the fixing portion provided in the cylindrical member, the formation position of the reinforcing member could be easily determined, and the reinforcing member could be firmly attached.

In addition, in configuring the cylindrical health device of the invention, it is preferable that embossed patterns are provided on a surface of the cylindrical member.

By providing the embossed patterns at a predetermined location of the cylindrical member, even when the cylindrical health device is reduced in weight and is made thinner, the cylindrical member is enabled to withstand a considerable weight and to effectively exhibit a predetermined springiness (elasticity).

In addition, in configuring the cylindrical health device of the invention, it is preferable that a non-formed portion (may also be referred to as a flat portion) in which the embossed patterns are not formed is provided at a predetermined distance from an end portion of the cylindrical member along the longitudinal direction of the cylindrical member.

The mechanical strength or the like of the end portion of the cylindrical member, which is prone to being subjected to a weight load and is prone to damage, could be selectively increased by providing the non-formed portion, in which the embossed patterns are not provided, at the end portion of the cylindrical member.

In addition, in configuring the cylindrical health device of the invention, it is preferable that the foamed resin of the treatment portion includes at least a foamed resin containing a first coloring agent, a foamed resin containing a second coloring agent having a hue different from a hue of the first coloring agent, and a foamed resin containing a third coloring agent having a hue different from the hues of the first coloring agent and the second coloring agent.

By adopting such a configuration, when the cylindrical health device is used for a predetermined treatment, the treatment portion having a camouflage pattern and made of a plurality of the foamed resins is provided on the surface, as a result of which the cylindrical health device having high visual attraction and improved design could be realized, and the customer attraction effect at stores could be increased.

In addition, in configuring the cylindrical health device of the invention, when the reinforcing member provided at least at the central portion is referred to as a first reinforcing member, it is preferable that a second reinforcing member is provided at both end portions or one end portion of the cylindrical member.

By adopting such a configuration, due to the structure of the cylindrical member, the durability of the end portion that is likely to be weakened by a load during treatment could be improved, and damage or the like due to a load could be prevented.

In addition, the inside of the cylindrical member could be used through the opening, and a strap or the like that could be used to carry the cylindrical health device could be used through the opening.

Furthermore, the opening ratio (the ratio of the area of the opening to the total area (100%)) could be adjusted to a desired range by appropriately changing the size or the like of the opening, thereby achieving a balance between weight reduction and improved mechanical strength with higher precision.

In addition, another aspect of the invention is a method for manufacturing any one of the cylindrical health devices described above, the method including the following steps (A) to (D):
(A) a step of preparing a first cylindrical member in which at least the reinforcing member is provided in advance or a second cylindrical member to which the reinforcing member is later fixed, the adhesive layer, and a sheet-shaped material for the treatment portion in a foamed state derived from a plurality of foamed resins;
(B) a step of forming the cylindrical health device by wrapping the sheet-shaped material for the treatment portion in a foamed state around the cylindrical member via the adhesive layer;
(C) a step of compression-molding the sheet-shaped material for the treatment portion by accommodating the cylindrical health device inside a mold and then heating and pressurizing the cylindrical health device; and
(D) a step of attaching the reinforcing member to the second cylindrical member when the second cylindrical member is used.

In this way, even when the overall weight is reduced, the cylindrical health device that withstands a considerable weight could be manufactured by performing the predetermined steps (A) to (D).

Therefore, the cylindrical health device that induces recovery from adhesions or tension in human fascia, muscles, or the like when used for a predetermined treatment could be efficiently manufactured.

### BRIEF DESCRIPTION OF THE DRAWINGS

FIGS. 1A to 1C are a front view, a cross-sectional view (in a longitudinal direction), and a cross-sectional view (in a direction orthogonal to the longitudinal direction), respectively, provided for describing a cylindrical health device including a reinforcing member according to the invention;

FIGS. 2A and 2B are views provided for describing a perspective view and a cross-sectional view (in the longitudinal direction) of the cylindrical health device including a second reinforcing member according to the invention;

FIGS. 3A to 3C are views provided for describing a reinforcing plate of a cylindrical member according to the invention;

FIGS. 4A to 4C are views provided for describing the inclination angle of side walls of embossed patterns of the invention;

FIGS. 5A to 5C are views provided for describing one example of a method for manufacturing the cylindrical member and the reinforcing member;

FIG. 6A is a view (photograph) showing a state where a central portion is pressed when obtaining a stress curve of the cylindrical health device, and FIG. 6B is a view (photograph) showing a state where an end portion is pressed when obtaining a stress curve of the cylindrical health device;

FIG. 7A is a view showing a stress-strain curve when a central portion of a cylindrical health device corresponding to Example 1 of the invention is pressed, and FIG. 7B is a view showing a stress-strain curve when a central portion of a cylindrical health device corresponding to Comparative Example 1 of the invention is pressed;

FIG. 8A is a view showing a stress-strain curve when an end portion of the cylindrical health device corresponding to Example 1 of the invention is pressed, and

FIG. 8B is a view showing a stress-strain curve when an end portion of the cylindrical health device corresponding to Comparative Example 1 of the invention is pressed;

FIGS. 9A to 9D are side views for describing a method for manufacturing the cylindrical health device according to the invention; and

FIG. 10 is a view provided for describing a conventional massage roller.

### DETAILED DESCRIPTION OF THE PREFERRED EMBODIMENTS

### First Embodiment

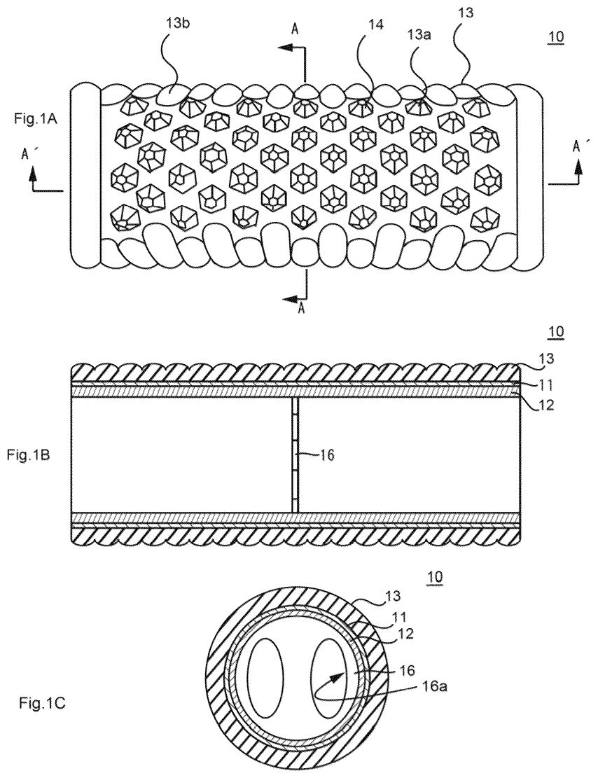

A first embodiment is a cylindrical health device 10 including, from the inside (the center of the cylindrical health device) toward the outside along a radial direction as shown in FIGS. 1A to 1C, at least a cylindrical member 12, an adhesive layer 11, and a treatment portion 13. The treatment portion 13 is made of a foamed resin 14, and a reinforcing member 16 is provided at least at a central portion of the cylindrical member 12 along a longitudinal direction.

Namely, a cross-sectional view taken along line A-A in FIG. 1A corresponds to the mode of FIG. 1C, and a cross-sectional view taken along line A′-A′ in FIG. 1A corresponds to the mode of FIG. 1B.

Hereinafter, the cylindrical health device 10 of the first embodiment will be specifically described with reference to the drawings as appropriate.

### 1. Cylindrical Member

As shown in FIGS. 1A to 1C, the cylindrical health device 10 of the first embodiment includes at least the cylindrical member 12 and the predetermined treatment portion 13, and has a multi-layer structure in which the cylindrical member 12 is used as a base portion and at least the treatment portion 13 having high cushioning is laminated from the inside toward the outside along the radial direction.

Namely, by adopting such a multi-layer structure, durability against load could be improved, and even when a predetermined weight load (for example, 40 MPa or more) is applied during treatment using the cylindrical health device, damage to the external shape and the like could be prevented.

In addition, the cylindrical member is a thin-walled cylindrical object having an internal space of a predetermined volume, and maintains lightweight while allowing the inside of the cylindrical member to be used for various purposes. Therefore, the inside of the cylindrical member could also be used as a simple storage place for shoes, a plastic bottle, or the like or as a through-hole for passing a carrying strap or the like.

### (1) Constituent Component

The constituent components of the cylindrical member 12 shown in FIG. 1 and the like are not particularly limited as long as the constituent components enable the cylindrical health device 10 to sufficiently support a single user's own weight (for example, a body weight of 200 kg or more) and have suitable mechanical strength.

For this reason, it is preferable that a constituent resin is used since the constituent resin is relatively lightweight and relatively inexpensive, and it is preferable that the constituent resin is composed of a resin composition containing any one of acrylonitrile-butadiene-styrene copolymer resin (ABS resin), polycarbonate resin, and polyester resin as a main component.

The reason is that, by using these resins, the cylindrical health device including the cylindrical member is enabled to keep lightweight while having an allowable weight load of at least 40 MPa even when the wall thickness is made as thin as 5 mm or less, thereby sufficiently withstanding the weight load during treatment.

Furthermore, it is more preferable that among the constituent resins of the cylindrical member described above, ABS resin is used as the main component.

The reason is that since ABS resin has considerable rubber elasticity while maintaining the fluidity of the resin, ABS resin is relatively lightweight while having good mechanical properties such as rigidity and impact resistance, and also facilitates thin-wall processing and embossing.

In addition, the reason is that ABS resin could be colored while being glossy without being subjected to painting by controlling the temperature during injection molding, and the adhesion between ABS resin and the cushion layer is also relatively good.

Furthermore, the reason is that ABS resin has good shock absorption or durability since ABS resin bends appropriately when subjected to a load.

In addition, it is also preferable that among the above-described resin materials, polycarbonate resin is used as the main component.

The reason is that polycarbonate resin is a resin exhibiting very good physical properties such as impact resistance and dimensional stability, and could further improve the durability of the cylindrical health device against load.

### (2) Length

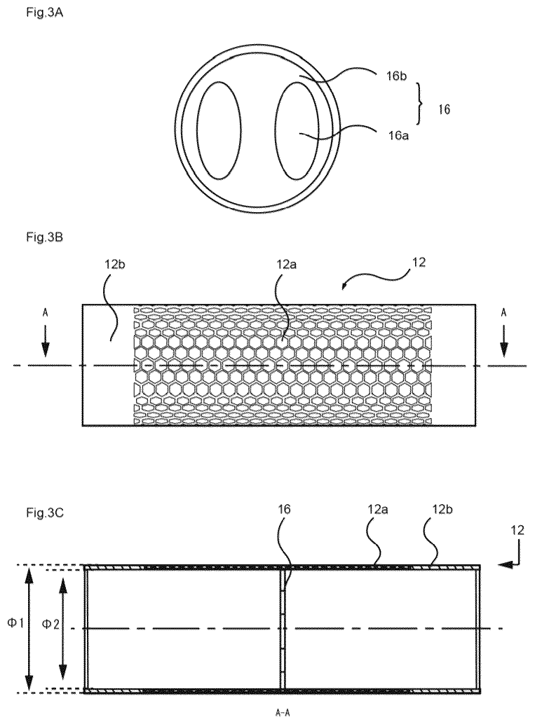

The axial length of the cylindrical member 12 shown in FIGS. 3B and 3C and the like is not particularly limited; however, when the axial length is excessively short, the range where the cylindrical member 12 could come into contact with a human body is reduced, as a result of which the treatment effect may not be efficiently obtained, and on the other hand, when the axial length is excessively long, handleability is reduced, as a result of which carrying or treatment in a narrow space may become difficult.

Namely, by adjusting the axial length of the cylindrical member 12 to a value within a suitable range, it is made easier to efficiently obtain treatment effect, and manageability is improved, as a result of which treatment that does not require an excessively large space could be performed.

Therefore, more specifically, the axial length of the cylindrical member is preferably set to a value within the range of 15 to 60 cm, more preferably a value within the range of 20 to 50 cm, and still more preferably a value within the range of 25 to 40 cm.

### (3) Inner Diameter

FIG. 3C is a cross-sectional view of the cylindrical member 12 shown in FIG. 3B taken along line A-A, and the inner diameter (ϕ2) is not particularly limited; however, when the inner diameter is excessively small, the outer diameter (ϕ1) of the cylindrical member 12 or the thickness of the treatment portion 13 must be made excessively large in order to effectively obtain the treatment effect, as a result of which the overall weight may become excessively heavy.

On the other hand, when the inner diameter of the cylindrical member is excessively large, handleability is reduced, as a result of which carrying may become difficult or treatment may not be performed depending on the physique of a user.

For this reason, the inner diameter of the cylindrical member is preferably set to a value within the range of 5 to 18 cm, more preferably a value within the range of 6 to 16 cm, and still more preferably a value within the range of 8 to 15 cm.

### (4) Embossed Pattern

It is preferable that the surface of the cylindrical member 12 is provided with embossed patterns 12a as shown in FIG. 3B.

The reason is that, by providing embossed patterns at a predetermined location of the cylindrical member, the weight load-bearing capacity is improved and the cylindrical health device is enabled to withstand a considerable weight from the outside even when the overall weight of the cylindrical health device is reduced.

Here, the surface of the cylindrical member refers to an outer surface and an inner surface of the cylindrical member or one thereof, and it is preferable that the surface includes at least the outer surface of the cylindrical member.

The reason is that, by providing embossed patterns on the outer surface of the cylindrical member, it is made easier to remove a mold without causing damage to the embossed patterns after the cylindrical member is molded, and therefore, the strength of the cylindrical member could be further increased.

In addition, the embossed patterns are not particularly limited; however, typically, it is preferable that the embossed patterns have at least one shape selected from among a dot shape (typically, circles, ellipses, irregular dots), a line shape, a wave shape, a curved shape, a polygonal shape (for example, triangles to dodecagons), a mountain shape, a honeycomb shape (regular hexagonal shape), and the like.

Particularly, as shown in FIG. 3B, when the embossed patterns 12a have a honeycomb shape (regular hexagonal shape), the embossed patterns 12a could be patterned and molded with high precision.

At the same time, even when the cylindrical member is made thinner, since the cylindrical member could also withstand a weight load equal to or larger than a predetermined level and exhibit high strength, a honeycomb shape is suitable for the embossed patterns.

Furthermore, when the embossed patterns have a honeycomb shape or the like, typically, it is preferable that each side has a value within the range of 3 to 8 mm and a center-to-center distance between adjacent honeycomb shapes or the like is set to a value within the range of 6 to 16 mm.

In addition, the size (planar area) of the embossed patterns is also not particularly limited; however, typically, it is preferable that the center-to-center distance between adjacent embossed patterns (or the distance between adjacent embossed patterns) is set to a value within the range of 5 to 20 mm.

The reason is that, when the center-to-center distance of the embossed patterns is a value of below 5 mm or a value of above 20 mm, it may become difficult to mold the embossed patterns with high precision or it may become difficult to reduce the weight of the cylindrical member while maintaining mechanical strength.

Therefore, the center-to-center distance of the embossed patterns is more preferably set to a value within the range of 8 to 18 mm, and still more preferably a value within the range of 10 to 15 mm.

Furthermore, the depth of the embossing is also not particularly limited; however, typically, it is preferable that the depth is set to a value within the range of 0.1 to 5 mm.

The reason is that, when the depth of the embossing is a value of below 0.1 mm or a value of above 5 mm, it may become difficult to mold the embossing with high precision or it may become difficult to reduce the weight of the cylindrical member while maintaining mechanical strength.

Therefore, the depth of the embossing is more preferably set to a value within the range of 0.3 to 3 mm, and still more preferably a value within the range of 0.5 to 2 mm.

However, as shown in FIG. 3B, it is preferable that non-formed portions (may also be referred to as flat portions) in which the embossed patterns are not provided are provided at a predetermined distance 12b from end portions of the cylindrical member along the longitudinal direction of the cylindrical member 12.

The reason is that the mechanical strength of the end portions of the cylindrical member that are prone to being subjected to a weight load could be increased by providing the non-formed portions, in which the embossed patterns are not provided, at predetermined places.

Conversely, the reason is that, even when the embossed patterns are provided on the surface of the cylindrical member, providing the embossed patterns all the way to the end portions may reduce the mechanical strength of the end portions, thereby causing the end portions to be prone to damage.

Therefore, it is preferable that the embossed patterns are provided on the surface of the cylindrical member except for both end portions.

More specifically, the embossed patterns are preferably provided at a location 3 cm or more away from the end portions, more preferably at a location 4 cm or more away from the end portions, and still more preferably at a location 5 cm or more away from the end portions.

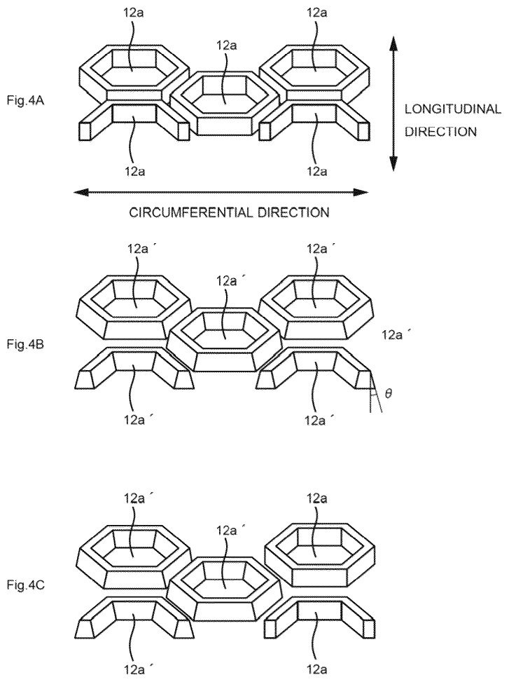

In addition, as shown in FIG. 4A, it is preferable that the angle of the side walls of the embossed patterns 12a along a depth direction thereof is perpendicular to the radial direction of the cylindrical member.

The reason is that the strength could be further increased by setting the side walls to be perpendicular to the cylindrical member in this way.

Meanwhile, as shown in FIG. 4B, it is also preferable that the angle of the side walls of the embossed patterns 12a along the depth direction is inclined at a predetermined inclination angle θ with respect to an axis along the radial direction of the cylindrical member.

The reason is that, by configuring the side walls to be inclined, the embossing could be more effectively prevented from collapsing due to interference between irregularities on the mold side and irregularities molded on the cylindrical member when a mold for molding the embossing on the cylindrical member is removed.

Therefore, the inclination angle of the side wall is not particularly limited; however, typically, it is preferable that the side walls are preferably inclined at an angle of 5 to 60° with respect to the axis along the radial direction of the cylindrical member, more preferably at an angle of 10 to 50°, and still more preferably at an angle of 15 to 45°.

In addition, as shown in FIG. 4C, it is preferable that the side walls of the embossed patterns 12a have at least two different inclination angles along a circumferential direction.

The reason is that the embossed patterns could be molded with higher precision according to the shape and the like of the mold by causing the side walls to have a plurality of inclination angles in this way.

Therefore, a difference between a largest inclination angle and a smallest inclination angle (including the embossed patterns that are not inclined) is preferably set to 60° or less, more preferably 45° or less, and still more preferably 30° or less.

Specifically, it is preferable that the inclination angles of the side walls of the embossed patterns are determined based on the shape and the like of the mold for molding the embossed patterns.

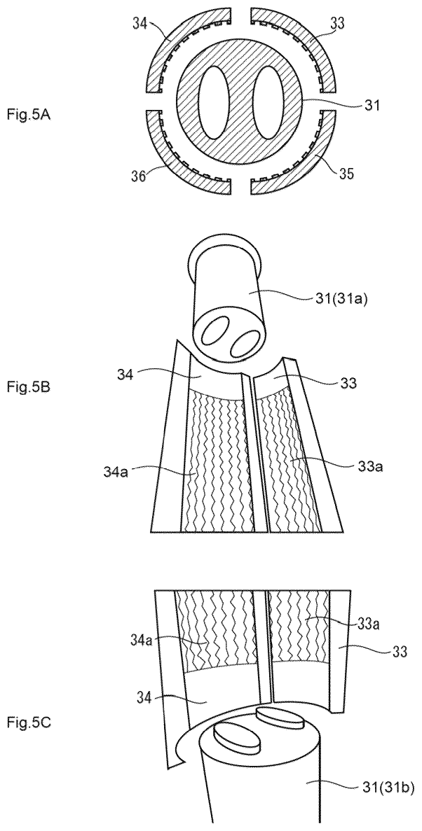

For example, as shown in FIG. 5A, in the case of a configuration in which four equally divided outer molds 33 to 36 having an arc shape for molding the embossed patterns are disposed along the circumferential direction and move radially, it is preferable that the inclination angle θ of the side walls of the embossed patterns in a central portion of each mold having an arc shape is 0° and the inclination angle of the side walls of the embossed patterns at end portions is within the range of 5 to 60°.

The reason is that, by changing the inclination angle of the side walls in this way, the embossed patterns could be provided in alignment with a direction in which the molds are removed, and the strength of the cylindrical member could be more efficiently maintained while preventing the molded irregularities from collapsing.

In this case, it is preferable that the inclination angle of the embossed patterns continuously increases from the center toward the end portions of the molds having an arc shape; however, from the viewpoint of facilitating the manufacture of the molds, a configuration in which the inclination angle increases in a stepwise manner is also preferable.

### (5) Outer Diameter

The outer diameter (ϕ1) of the cylindrical member 12 shown in FIG. 3C is not particularly limited; however, it is preferable that the outer diameter (ϕ1) is a size corresponding to the inner diameter (ϕ2) and thickness of the cylindrical member 12 and causes the weight and strength of the cylindrical member 12 to be kept within a suitable range.

For this reason, a difference between the outer diameter (ϕ1) and the inner diameter (ϕ2) of the cylindrical member 12, namely, which corresponds to twice the wall thickness, is preferably set to a value within the range of 0.5 to 12 mm, more preferably a value within the range of 0.8 to 10 mm, and still more preferably a value within the range of 1 to 8 mm.

In addition, the inner diameter of the cylindrical member does not need to be uniform, and it is preferable that the inner diameter at an axial midpoint of the cylindrical member is made larger than the inner diameter at the end portions.

The reason is that, by making the inner diameter at the axial midpoint of the cylindrical member larger than the inner diameter at the end portions, the overall weight load-bearing capacity could be increased even when a weight load is applied to the middle portion.

Therefore, more specifically, the inner diameter at the axial midpoint of the cylindrical member is preferably set to be equal to or larger than 1.01 times the inner diameter at the end portions, more preferably a value within the range of 1.02 to 1.3, and still more preferably a value within the range of 1.05 to 1.2.

Meanwhile, when mold molding by a drawing method or the like is used, it is preferable that the inner diameter at the end portions is made larger than the inner diameter at the axial midpoint of the cylindrical member.

The reason is that, when the inner diameter of the cylindrical member is made uniform, it may become difficult to remove the cylindrical member from the mold during molding. Namely, the cylindrical member could be easily removed from the mold by adopting such a configuration, thereby being able to shorten the time required for the manufacture of the cylindrical health device.

Therefore, when mold molding by a drawing method or the like is used, the inner diameter at the end portions is preferably set to be equal to or larger than 1.01 times the inner diameter at the axial midpoint of the cylindrical member, more preferably a value within the range of 1.02 to 1.3, and still more preferably a value within the range of 1.05 to 1.2.

### 2. Adhesive Layer

As shown in FIG. 1A, it is preferable that the cylindrical health device of the first embodiment includes the adhesive layer 11 between the cylindrical member 12 and the treatment portion 13.

In this way, by providing the adhesive layer 11, the cylindrical member 12 and the treatment portion 13 could be made to suitably fixed to each other, and during treatment, the cylindrical member 12 and the treatment portion 13 could be prevented from being misaligned or peeling off from each other, and the structural stability and durability of the cylindrical health device could be further improved.

Here, the constituent components of the adhesive layer 11 shown in FIG. 1B and the like are not particularly limited as long as the constituent components have good adhesiveness for the fixation between the cylindrical member 12 and the treatment portion 13.

Therefore, it is preferable that any one of acrylic resin, silicone resin, urethane resin, thermoplastic elastomer, and the like is used as a main component since these resins have good adhesiveness and are relatively inexpensive.

Particularly, the adhesive layer containing acrylic resin as the main component is a suitable adhesive since acrylic resin fills a gap between the cylindrical member 12 and the treatment portion 13, exhibits strong adhesiveness, and therefore, there is little problem of peeling even when the treatment portion 13 is formed by foaming or the like.

In addition, it is preferable that the adhesive layer is formed as a double-sided adhesive tape and the thickness of the adhesive layer is set to a value within the range of 10 to 3000 μm.

The reason is that, by setting the thickness of the adhesive layer 11 to 10 μm or more, suitable adhesiveness could be kept and the cylindrical member 12 and the treatment portion 13 could be more firmly fixed to each other.

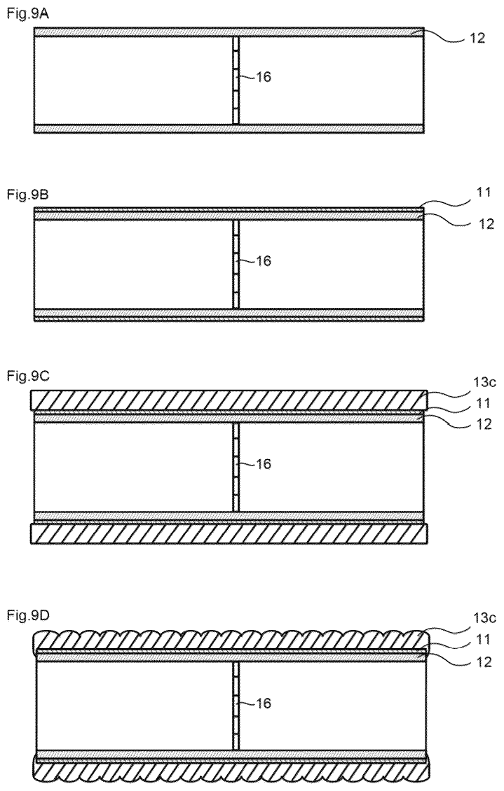

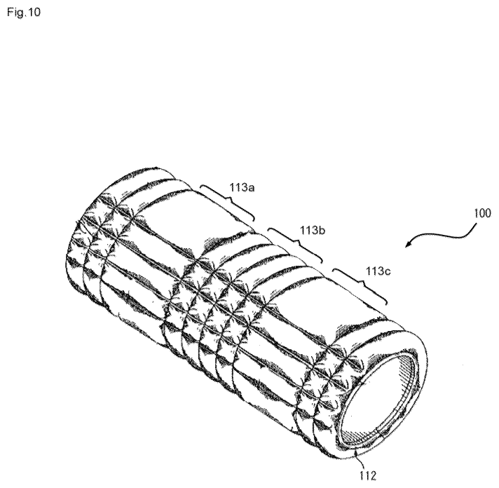

In addition, the reason is that, by setting the thickness of the adhesive layer 11 to 3000 μm or less, as shown in FIGS. 9C and 9D and the like, the adhesive layer 11 could be molded to be covered up to the end portions with the treatment portion 13, thereby being able to prevent poor appearance or the like due to leakage of the adhesive.

Therefore, the thickness of the adhesive layer is more preferably set to a value within the range of 20 to 1000 μm, and still more preferably a value within the range of 30 to 500 μm.

In addition, it is also preferable that the adhesive layer 11 has a multi-layer structure since the multi-layer structure facilitates handleability and further improves mechanical properties. Namely, it is also preferable that the adhesive layer 11 is configured as a double-sided adhesive tape in which an adhesive layer is provided on each of a front surface and a back surface of an intermediate layer made of a PET film or the like.

### 3. Treatment Portion

As shown in FIGS. 1B and 1C and the like, the cylindrical health device 10 of the first embodiment is configured such that the treatment portion 13 derived from a foamed resin is laminated on the side surface of the cylindrical member 12, which serves as the base portion, via the adhesive layer 11.

By configuring the cylindrical health device in this way, the cylindrical member is provided thereinside, so that the cylindrical health device has durability against weight load, and the treatment portion having cushioning, durability, or the like is provided, so that the cylindrical health device could exhibit good treatment effectiveness.

### (1) Foamed Resin Layer

The treatment portion 13 shown in FIGS. 1A to 1C and the like includes a foamed resin layer.

The reason is that, by adopting a configuration in which the foamed resin layer is included, the cylindrical health device could exhibit a predetermined level of cushioning while having a strength suitable for treatment.

Therefore, it is preferable that the foamed resin layer is made of at least one of foamed urethane resin, foamed EVA resin, and foamed styrene resin since these resins are relatively inexpensive, lightweight, and have good durability.

In addition, by forming the above-described foamed resin layer as a foamed resin layer having a camouflage pattern derived from a plurality of foamed resins, the customer attraction effect of the cylindrical health device at stores could be increased, and the cylindrical health device could have a crime prevention effect.

The reason is that the design and visual attraction of the cylindrical health device are improved by providing the foamed resin layer having a camouflage pattern derived from the plurality of foamed resins, and due to the improvement in visual attraction, the cylindrical health device is more noticeable when carried around.

It is preferable that the plurality of foamed resins include at least a foamed resin containing a first coloring agent, a foamed resin containing a second coloring agent having a hue different from that of the first coloring agent, and a foamed resin containing a third coloring agent having a hue different from those of the first coloring agent and the second coloring agent.

The reason is that the cylindrical health device with more improved design and visual attraction could be obtained by adopting such a configuration.

In addition, the reason is that fading or peeling that occurs when the surface is colored by painting or printing could be prevented by forming the cylindrical health device from foamed resins containing coloring agents.

### (2) Surface Shape

It is preferable that the treatment portion 13 shown in FIGS. 1A to 1C and the like includes a plurality of irregularities 13a having a pyramid shape (may also be referred to as projections) or irregularities 13b having a band shape different from the pyramid shape and disposed along a rotatable direction on the surface of the foamed resin layer so as to be able to accommodate various types of treatments.

The reason is that, during treatment, stimulation could be more suitably applied while pressing or rotating the cylindrical health device, and adhesions or tension in human fascia, muscles, or the like could be relieved, thereby inducing recovery of the human fascia, muscles, or the like to a normal state.

The shape of the plurality of irregularities is not particularly limited; however, it is preferable that the plurality of irregularities having different shapes such as pyramid-shaped or dome-shaped protrusions are formed depending on the position on the surface of the treatment portion.

### (3) Thickness

The thickness of the treatment portion 13 shown in FIGS. 1A to 1C and the like is not particularly limited; however, when the thickness is too thin, the treatment portion 13 may not exhibit suitable cushioning, and a good treatment effect may not be obtained.

In addition, when the treatment portion is too thick, the weight increases, as a result of which handleability may be reduced.

For this reason, the thickness of the treatment portion is preferably set to a value within the range of 0.8 to 3 cm, more preferably a value within the range of 0.9 to 2.5 cm, and still more preferably a value within the range of 1 to 1.8 cm.

### (4) Density

The density of the treatment portion 13 shown in FIGS. 1A to 1C and the like is not particularly limited; however, it is preferable that the density could exhibit suitable cushioning and is appropriately adjusted according to the constitution of a user or the treatment.

In addition, when the treatment portion has different densities for each portion, the cushioning of each portion changes, and therefore, a difference occurs in feel of use, and there is also a possibility that the treatment portion could be used according to the treatment. However, when the thickness of the treatment portion is kept within a predetermined range so as to prevent the weight from becoming excessively heavy, it is difficult to create a difference in feel of use for each portion to the extent that the treatment portion could be used according to the treatment.

Furthermore, when the treatment portion has different densities for each portion when molded, the time required for molding and the cost increase.

For this reason, it is preferable that the overall density of the treatment portion does not differ significantly, or rather, is substantially equal and uniform.

More specifically, the density of the treatment portion is kept constant, and is preferably set to a value within the range of 20 to 80 g/cm³, and more preferably a value within the range of 30 to 70 g/cm³ when measured by a density measurement method based on the JIS K7312 standard.

### 4. Connecting Portion

In addition, although not shown, it is preferable that the cylindrical health device could be divided into a plurality of pieces along an axial direction including at least a first cylindrical health device and a second cylindrical health device and a connecting portion is provided between the first cylindrical health device and the second cylindrical health device.

The reason is that the axial length of the cylindrical health device could be appropriately changed according to the body type of a user and the method of use.

Here, the configuration of the connecting portion is not particularly limited; however, it is preferable that the first cylindrical health device and the second cylindrical health device have a fitting structure, a screw structure, or the like in which the respective cylindrical members serve as receiving ports, and the relative position between the first cylindrical health device and the second cylindrical health device could be fixed with a strength sufficient to withstand treatment.

Furthermore, it is also preferable that a predetermined reinforcing member is laminated or a fitting portion is provided and combined to correspond to the connecting portion, or both are integrally formed by resin molding using a mold or the like.

### 5. First Reinforcing Member

As shown in FIGS. 1B and 1C, it is preferable that the cylindrical health device 10 includes the reinforcing member 16 at least at the central portion of the cylindrical member 12 along the longitudinal direction.

The reason is that, due to the structure of the cylindrical member, the vicinity of the central portion is particularly prone to bending and deforming when pressed from the outside during treatment.

Therefore, the reason is that, by providing the predetermined reinforcing member in the vicinity of the central portion that is prone to bending, durability could be significantly improved and damage to the cylindrical member as a whole could be prevented even when pressurized from the outside due to treatment or the like.

In addition, even when the predetermined reinforcing member is provided in the vicinity of the central portion that is prone to bending, the flexibility and softness of the treatment portion does not change fundamentally, and the predetermined reinforcing member could contribute to an effective fascial massage of a practitioner.

Furthermore, since the overall mechanical strength of the cylindrical member is increased, the reinforcing member could also contribute to the thinning or weight reduction of the cylindrical member.

Here, it is preferable that the central portion is located at a distance of half the axial length from one end portion of the cylindrical member; however, a portion could be considered to correspond to the central portion as long as the portion is located within the range of ⅓ to ⅔ of the axial length from one end portion of the cylindrical member.

### (1) Shape

The shape of the reinforcing member is not particularly limited; however, typically, it is preferable that the reinforcing member 16 has a plate shape as shown in FIG. 3A and the like such that the reinforcing member 16 is easily accommodated inside the cylindrical member of the cylindrical health device.

The reason is that, during treatment, the reinforcing member could bend appropriately to absorb a weight load at a location prone to deforming (the central portion along the longitudinal direction), and the mechanical strength or durability of the cylindrical health device could be significantly increased.

Therefore, in the case of a plate-shaped reinforcing member, typically, the thickness is preferably set to a value within the range of 0.5 to 10 mm, more preferably a value within the range of 1 to 8 mm, and still more preferably a value within the range of 2 to 5 mm.

In addition, it is preferable that the shape of the reinforcing member is a circular shape or an elliptical shape in a plan view since the circular shape or the elliptical shape enables the reinforcing member to easily withstand a weight load in any direction from the outside and enables the reinforcing member to be easily fitted and fixed inside the cylindrical member.

### (2) Opening

In addition, as shown in FIG. 3A and the like, it is preferable that the reinforcing member 16 includes one or two more openings 16a.

The reason is that the openings (may also be referred to as through-holes) could achieve the weight reduction and thinning of the reinforcing member and the openings are gripped to fix the reinforcing member, and therefore, handleability could be improved.

In addition, the reason is that such openings enable the entire inside of the cylindrical member to be widely used and also serve as air passages not to hinder ventilation.

Furthermore, a strap or the like that could be used to carry the cylindrical health device could also be firmly used through the openings.

Furthermore, the opening ratio (the ratio of the area of the openings to the total area (100%)) could be adjusted to a desired range by appropriately changing the size or the like of the openings of the reinforcing member, thereby achieving a balance between weight reduction and improved mechanical strength with higher precision.

More specifically, the opening ratio of the reinforcing member is preferably set to a value within the range of 10 to 90%, more preferably a value within the range of 30 to 80%, and still more preferably a value within the range of 40 to 60%.

In addition, the shape of the openings is not particularly limited; however, it is preferable that the shape of the openings is a circular shape, an elliptical shape, a diamond shape, or other polygonal shapes (for example, triangular to dodecagonal shapes) when the reinforcing member is viewed from above.

The reason is that such a shape contributes to reducing the overall weight without excessively reducing the strength of the reinforcing member.

Therefore, a circular shape, an elliptical shape, or an octagonal shape is particularly preferable since these shapes make it difficult for stress concentration to occur during deformation.

In addition, it is preferable that the openings are disposed in the reinforcing member at positions that are line-symmetric with respect to an imaginary center line of the cylindrical member in the radial direction, or at positions that are point-symmetric with respect to an imaginary center point of the cylindrical member in the radial direction.

The reason is that, even when the cylindrical member rolls and a direction in which a load is applied changes, deformation of the cylindrical member could be more stably prevented.

### (3) Quantity

The number of the reinforcing members is not particularly limited as long as the reinforcing members have a strength that could improve the mechanical properties or durability of the inside of the cylindrical member.

Therefore, typically, one to four reinforcing members are preferably provided, more preferably one to three reinforcing members, and still more preferably one to two reinforcing members.

Furthermore, when a plurality of the reinforcing members are provided, it is preferable that the plurality of reinforcing members are evenly disposed in the longitudinal direction inside the cylindrical member; however, in order to particularly strengthen the vicinity of the central portion, it is also preferable that the plurality of reinforcing members are selectively disposed such that the number of the reinforcing members in the vicinity of the central portion is larger than that at the end portions.

The above-described opening ratio could also be adjusted to a desired range by appropriately changing the number and size of the reinforcing members, thereby achieving a balance between weight reduction and improved mechanical strength with higher precision.

### (4) Constituent Material

The constituent material of the reinforcing member is not particularly limited as long as the constituent material has a strength that could improve the mechanical properties, durability, or the like of the inside of the cylindrical member.

Therefore, it is preferable that general-purpose plastics are used since the general-purpose plastics are lightweight and inexpensive, and more specifically, it is preferable that relatively inexpensive resins having good processability and high mechanical strength or durability, such as ABS resin, polycarbonate resin, and polyester resin, are used as main components.

### (5) Fixing Member

As shown in FIGS. 1B and 1C and the like, it is preferable that a fixing member (not shown) for fixing the reinforcing member 16 to a predetermined location (the central portion of the like) of the cylindrical member 12 is provided.

The reason is that the formation position of the reinforcing member could be accurately determined, and the entire inside of the cylindrical member 12 could be widely used through the openings, thereby being able to insert and use a strap or the like that could be used to carry the cylindrical health device.

Here, the mode of the fixing member is not particularly limited, and it is preferable that the fixing member is configured as one or a plurality of projection portions, one or a plurality of grooves (recesses), or a wall member provided at the predetermined location of the cylindrical member.

The reason is that such a projection portion, groove, or wall member could be provided at the predetermined location (the central portion of the like) of the cylindrical member with high precision, and the reinforcing member could be firmly fixed at an accurate position at the predetermined location (the central portion or the like) of the cylindrical member by bringing the reinforcing member into contact therewith or fitting the reinforcing member thereto.

Moreover, the reason is that the formation position of the reinforcing member could also be easily changed by appropriately changing the position of such a fixing member.

In addition, it is also preferable that the reinforcing member is provided integrally as a part of the cylindrical member.

The reason is that it is made unnecessary to later fix the reinforcing member to the cylindrical member by integrally providing the reinforcing member in this way, thereby facilitating manufacturing.

In addition, the reason is that rattling caused by a gap or slight irregularities between the cylindrical member and the reinforcing member is prevented by integrally providing the reinforcing member, and therefore, the strength could be more effectively prevented from decreasing.

In addition, the method for integrally molding the reinforcing member is not particularly limited; however, it is preferable that, for example, as shown in FIGS. 5B and 5C, an outer mold 33 for molding the outside of the cylindrical member and an inner mold 31 for molding the inside of the cylindrical member are used.

Namely, it is preferable that, as shown in FIGS. 5B and 5C, the inner mold used to mold the reinforcing member is composed of a first inner mold 31a including recesses having a shape corresponding to the openings at an end portion of the first inner mold 31a, and a second inner mold 31b including protrusions having a shape corresponding to the openings at an end portion of the second inner mold 31b, the first inner mold 31a and the second inner mold 31b being disposed along an axial direction of a cylinder.

Next, it is preferable that the recesses of the first inner mold and the protrusions of the second inner mold are fitted to each other and the respective end portions are disposed with a predetermined gap therebetween.

Furthermore, it is preferable that the outer mold is disposed around the inner mold and the molten resin material is poured between the outer mold and the inner mold.

The reason is that, by adopting such a method, the cylindrical member could be molded from the resin material flowing into a gap between the inner mold and the outer mold, and the reinforcing member could be integrally molded from the resin material flowing into the gap between the first inner mold and the second inner mold.

### (6) Mechanical Strength

When the reinforcing member is inserted, it is preferable that a predetermined stress-strain curve (commonly known as an SS curve) measured in accordance with JIS K6767:1999 is obtained for the constituent material such that the mechanical strength of the central portion of the cylindrical member 12 could be suitably improved and confirmed.

Namely, the cylindrical health device (corresponding to Example 1) has embossed patterns having a honeycomb shape on a surface thereof, and is provided with a predetermined reinforcing member.

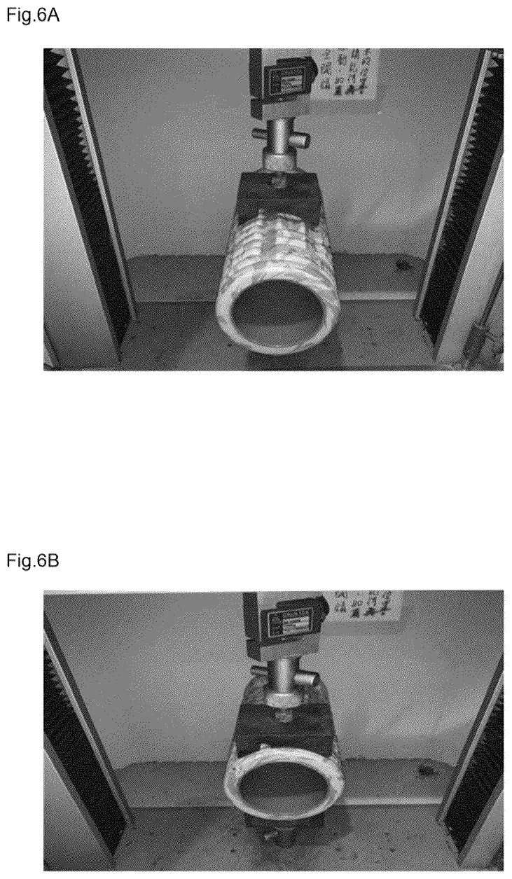

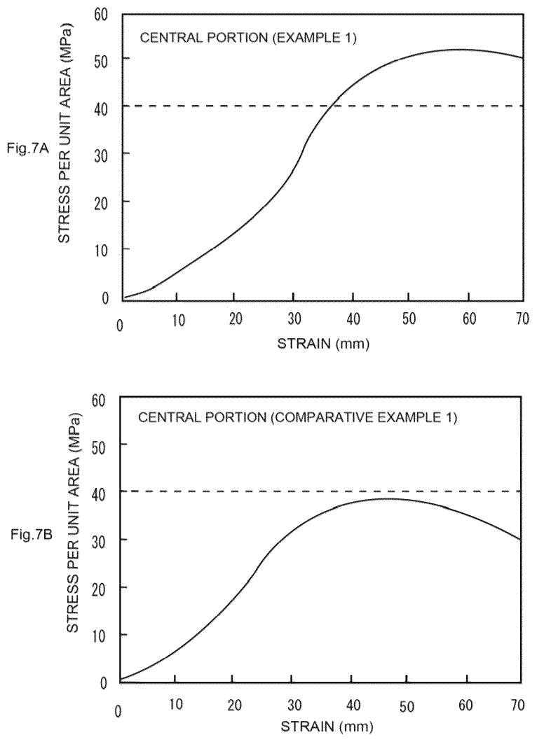

Therefore, when the central portion of the cylindrical health device (corresponding to Example 1) is pressed using a pressure measurement device as shown in FIG. 6A, the cylindrical health device could exhibit, for example, a high stress of up to 50 MPa per unit area (1 cm²) as shown in FIG. 7A.

Meanwhile, since the cylindrical health device (corresponding to Comparative Example 1) is not provided with a predetermined reinforcing member, when the central portion of the cylindrical health device is pressed using a pressure measurement device, the cylindrical health device exhibits, for example, a stress of approximately 40 MPa per unit area (1 cm²) as shown in FIG. 7B.

Therefore, the mechanical strength of at least the central portion of the cylindrical health device could be considerably increased by providing the predetermined reinforcing member in the central portion of the cylindrical health device.

Furthermore, by providing the embossed patterns having a honeycomb shape on the surface of the cylindrical member, the mechanical strength of the end portions of the cylindrical health device could be further increased compared to when the embossed patterns are not provided.

In addition, the cylindrical health device (corresponding to Example 1) does not have a honeycomb shape at the end portions for a distance of approximately 50 mm inward from the ends; but is provided with the predetermined reinforcing member.

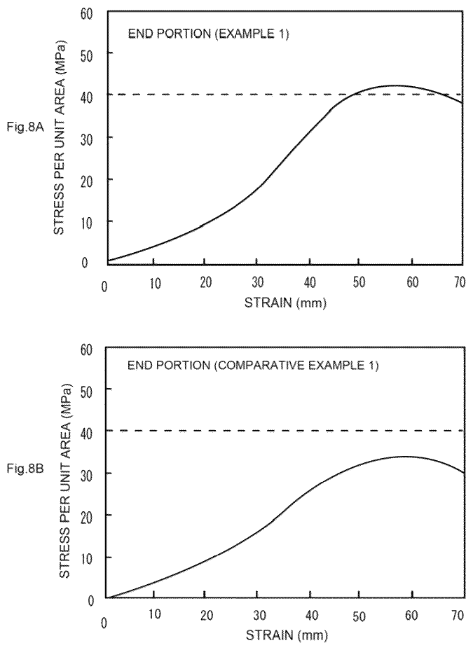

Therefore, when the end portion of the cylindrical health device (corresponding to Example 1) is pressed using a pressure measurement device as shown in FIG. 6B, the cylindrical health device could exhibit, for example, a high stress of up to 40 MPa per unit area (1 cm²) as shown in FIG. 8A.

Meanwhile, since the cylindrical health device (corresponding to Comparative Example 1) is not provided with the predetermined reinforcing member, when the end portion of the cylindrical health device is pressed using a pressure measurement device, as shown in FIG. 8B, the cylindrical health device exhibits, for example, a stress of up to approximately 34 MPa and below 35 MPa per unit area (1 cm²).

Therefore, the mechanical strength of the end portions of the cylindrical health device could also be considerably increased by providing the predetermined reinforcing member in the central portion of the cylindrical health device.

Furthermore, even when the embossed patterns are not provided at the end portions of the cylindrical member, the mechanical strength of the end portions of the cylindrical health device could be further increased, for example, by providing the embossed patterns in the central portion of the cylindrical member.

### 6. Second Reinforcing Member

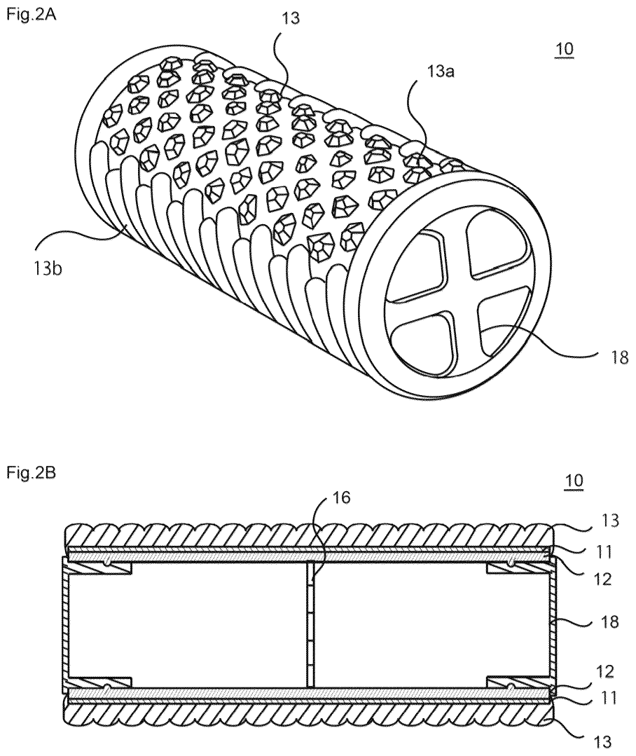

As shown in FIG. 2, in the cylindrical health device 10, when the reinforcing member provided at least at the central portion in the longitudinal direction is referred to as a first reinforcing member, it is preferable that a second reinforcing member 18 including a plurality of openings is further provided at both end portions or one end portion of the cylindrical member 12.

The reason is that, due to the structure of the cylindrical member, the durability against weight load during treatment becomes relatively lower as the end portion in the axial direction is approached, and the durability of the end portion is significantly improved by providing the second reinforcing member, thereby being able to effectively prevent damage or the like during use.

The shape of the second reinforcing member is not particularly limited; however, when the second reinforcing member is shaped to cover the end portion of the cylindrical member, the second reinforcing member having such a shape is not suitable for a method of use where the inside of the cylindrical member is used as an installation location for a carrying strap, and therefore the reinforcing member needs to be removed each time.

For this reason, it is preferable that the shape of the second reinforcing member includes a plurality of openings, and typically is a cross shape when viewed from one side.

Accordingly, the inside of the cylindrical member could be used through the plurality of openings, and even when a strap or the like that could be used to carry the cylindrical health device is used, the cylindrical health device could be used without removing the reinforcing member.

In addition, the constituent material of the second reinforcing member is not particularly limited as long as the constituent material has a strength that could suitably improve the durability of the end portion of the cylindrical member.

Therefore, it is preferable that general-purpose plastics are used since the general-purpose plastics are lightweight and inexpensive, and more specifically, it is preferable that ABS resin, polycarbonate resin, polyester resin, and the like are used as main components.

### 7. Method of Use

A method of using the cylindrical health device shown in FIG. 1 and the like is not particularly limited; however, it is preferable that the method includes, for example, at least two steps: a preparation step and a treatment step.

### (1) Preparation Step

The preparation step is a step of preparing a space for efficient use of the cylindrical health device shown in FIG. 1 and the like.

During treatment, it is preferable that the cylindrical health device is installed on a floor, a pedestal, or the like, and since a user may lie down, it is preferable that a sufficiently large space suitable for the physique of the user is prepared.

### (2) Treatment Step

The treatment step is a step in which the user performs treatment on a treatment target location using the cylindrical health device shown in FIG. 1 and the like.

More specifically, the preparation step is a step in which the user relieves adhesions or tension in fascia, muscles, or the like by bringing the treatment target location into contact with the treatment portion 13 of the cylindrical health device installed on a floor, a pedestal, or the like, and rotating the cylindrical health device while applying a load due to its own weight, thereby inducing recovery of the fascia, muscles, or the like to a normal state.

In the treatment step, when the cylindrical health device shown in FIG. 1 and the like is used, the treatment target location is not particularly limited, and treatment could be performed on various locations such as the abdomen, the back, thighs, arms, shins, and calves.

In addition, since the cylindrical health device shown in FIG. 1 and the like includes a plurality of irregularities, the cylindrical health device is not limited to simply pressing the treatment target location, and could apply a variety types of stimulation.

### Second Embodiment

A second embodiment is a method for manufacturing the cylindrical health device 10 that includes the following steps (A) to (C) as shown in FIGS. 9A to 9D.

(A) A step of preparing the cylindrical member 12 in which at least the reinforcing member 16 is provided in advance (hereinafter, may be referred to as a first cylindrical member) or the cylindrical member 12 to which the reinforcing member 16 is later fixed (hereinafter, may be referred to as a second cylindrical member), the adhesive layer 11, and a sheet-shaped material 13c for the treatment portion in a foamed state derived from a plurality of foamed resins.

(B) A step of forming the cylindrical health device 10 by wrapping the sheet-shaped material 13c for the treatment portion in a foamed state around the cylindrical member 12 via the adhesive layer 11.

(C) A step of compression-molding the sheet-shaped material 13c for the treatment portion by accommodating the cylindrical health device 10 inside a mold and then heating and pressurizing the cylindrical health device 10.

(D) A step of attaching the reinforcing member 16 to the second cylindrical member when the second cylindrical member is used.

Hereinafter, the second embodiment will be specifically described with reference to FIGS. 9A to 9D.

FIGS. 9A to 9D are views provided for describing the method for manufacturing the cylindrical health device.

### 1. Preparation Step (A)

As a part of the preparation step (A), as shown in FIG. 9A, each of the cylindrical member 12, the adhesive layer 11, and the sheet-shaped material 13c for the treatment portion having a camouflage pattern derived from the plurality of foamed resins, which constitute the cylindrical health device, is prepared.

Namely, first, the cylindrical member derived from ABS resin or the like serving as a constituent material is prepared.

Here, it is preferable that the cylindrical member is the first cylindrical member in which at least the reinforcing member is provided in advance.

The reason is that rattling caused by a gap or slight irregularities between the cylindrical member and the reinforcing member is prevented by integrally providing the reinforcing member, and therefore, the strength could be more effectively prevented from decreasing.

Meanwhile, from the viewpoint of simplifying the manufacturing device, it is also preferable that the cylindrical member is the second cylindrical member to which the reinforcing member is later fixed.

In addition, as a part of the preparation step (A), as shown in FIG. 9B, a double-sided adhesive tape or the like is prepared as the adhesive layer 11.

Then, as shown in FIG. 9C, the sheet-shaped material 13c for the treatment portion derived from the plurality of foamed resins is prepared. Namely, the sheet-shaped material obtained by foaming a predetermined foamed resin into a sheet shape is prepared.

Here, it is preferable that the sheet-shaped material is formed as a sheet-shaped material having a camouflage pattern by partially crosslinking resins containing coloring agents having a plurality of different hues while keeping the colors separated into a camouflage pattern.

The reason is that, by forming the sheet-shaped material in this way, even when the sheet-shaped material contains the plurality of resins having different hues, a camouflage pattern could be formed and fading or the like due to the friction of the surface could be prevented.

### 2. Affixing Step (B)

Next, in the affixing step (B), as shown in FIG. 9C, the cylindrical health device is formed by forming the adhesive layer 11 around the cylindrical member 12 and then affixing the sheet-shaped material 13c in a formed state (including a case where some of the sheet-shaped material is in an unfoamed state).

Furthermore, since the sheet-shaped material is affixed in a manner that the sheet-shaped material is wrapped around the cylindrical member, it is preferable that the length and the width of the sheet-shaped material correspond to the length and the outer diameter of the cylindrical member.

Here, it is found that the sheet-shaped material in a foamed state does not need to be completely foamed, and there is no problem even when the sheet-shaped material in an unfoamed state remains.

For example, when at least 10% of a foaming agent has reacted, by wrapping the sheet-shaped material around the cylindrical member, the treatment portion could be molded without causing molding defects or the like.

Therefore, before the sheet-shaped material is wrapped around the cylindrical member, it is more preferable that 30% or more of the foaming agent has reacted, and it is still more preferable that 50% or more of the foaming agent has reacted.

### 3. Forming Step (C)

The forming step (C) is a step in which the sheet-shaped material 13c is molded into the shape of the predetermined treatment portion by accommodating the cylindrical health device inside the mold (not shown) and then heating and pressurizing the cylindrical health device as shown in FIG. 9D.

More specifically, as shown in FIG. 9D, the treatment portion 13 is formed by accommodating the cylindrical health device, which incorporates the cylindrical member 12 as an insert component, inside the mold having a shape including a plurality of irregularities, and then heating and pressurizing the sheet-shaped material 13c.

Namely, in the step, the cylindrical member 12, the adhesive layer 11, and the treatment portion 13 derived from the sheet-shaped material 13c could be firmly bonded together by combining insert molding and compression molding.

In addition, in the step, the end portion of the cylindrical health device could be covered with the sheet-shaped material 13c so as to cover the end portion of the cylindrical member 12, and therefore, leakage of the adhesive layer 11 to the outside could be suppressed.

Therefore, the adhesive is not visible from the outside, so that poor appearance or the like of the cylindrical health device could be prevented.

Here, when some of the sheet-shaped material is in an unfoamed state, it is preferable that the sheet-shaped material is completely foamed when the sheet-shaped material is molded.

### 4. Attachment Step of Reinforcing Member (D)

The attachment step (D) is, although not particularly shown, a step in which, when the reinforcing member is later fixed, the reinforcing member (first reinforcing member) is attached typically to the central portion at a location equidistant from both ends along the longitudinal direction of the cylindrical member.

Namely, the reinforcing member having a plate shape and including a predetermined opening could be firmly attached via the fixing member such as a groove provided in the cylindrical member.

In addition, it is also preferable that an adhesive or a filler is partly contained in the fixing member, thereby further strengthening the fixation or adhesion between the reinforcing member and the fixing member.

Furthermore, as shown in FIGS. 2A and 2B, it is also preferable that the second reinforcing member 18 is mounted on both end portions or one end portion of the obtained cylindrical health device.

### EXAMPLES

Hereinafter, the invention will be further described in detail using examples.

Meanwhile, the invention is not limited to the description of the following examples without any particular reason.

### Example 1

### 1. Manufacture of Cylindrical Health Device

### (1) Formation of Cylindrical Member

A cylindrical member was formed by injection molding using a resin material containing ABS resin as a main component.

Namely, the cylindrical member had an axial length of 33.0 cm, an inner diameter of 13.0 cm, and an outer diameter of 13.5 cm.

In addition, when the cylindrical member was formed by injection molding, predetermined embossed patterns (honeycomb shape (regular hexagonal shape) with each side of 5 mm, center-to-center distance between the adjacent embossed patterns: 12 mm, and depth: 2.5 mm) were provided on the surface (excluding a location within a distance of 5 cm from the end portion) of the cylindrical member.

Furthermore, as a part of the cylindrical member, the reinforcing member 16 including an elliptical opening shown in FIG. 1C or 3A, which is a reinforcing member having a circular plate shape and a thickness of 4 mm, was integrally molded at the central portion of the cylindrical member along the longitudinal direction.

In addition, in order to reduce the weight of the reinforcing member 16, as shown in FIG. 1C or 3A, a configuration in which a pair of the openings 16a (opening ratio: 50%) having an elliptical shape were disposed evenly on the left and right sides of a center line assumed in the vicinity of a central portion of the reinforcing member 16 having a circular plate shape was adopted.

### (2) Formation of Adhesive Layer

A double-sided adhesive tape containing acrylic resin as a main component (adhesive transfer tape 927/950 manufactured by 3M Japan Ltd.) was used as the adhesive layer, and was affixed to the periphery of the cylindrical member. A thickness of the adhesive tape was 50 μm.

### (3) Formation of Sheet-Shaped Material for Treatment Portion

As the sheet-shaped material for the treatment portion, a resin molded article having a camouflage pattern in which three hues were separated was produced by adding coloring agents having the three different hues to EVA resin.

A sheet-shaped material having a camouflage pattern in a foamed state was produced by accommodating the resin molded article inside a mold, foaming the resin molded article through heating and pressurization, and then cutting the resin molded article into a plate shape.

At this time, the sheet-shaped material for the treatment portion having a camouflage pattern was formed by partially crosslinking the resin molded article as it is without performing stirring.

Next, the sheet-shaped material for the treatment portion in a foamed state was cut according to the length and outer diameter of the cylindrical member, and was affixed to the cylindrical member in a state where the sheet-shaped material for the treatment portion was wrapped therearound.

### (4) Molding Step of Sheet-Shaped Material

A treatment portion including a plurality of irregularities was formed by accommodating the cylindrical member inside a mold having a shape including a plurality of irregularities, the sheet-shaped material in a foamed state being affixed to the periphery of the cylindrical member, and molding the cylindrical member through heating and pressurization. The density of the formed treatment portion was about 0.3 g/cm³ at all surface locations.

The surface of the treatment portion was made smooth by cutting off burrs or the like that occur in the treatment portion at a separation portion of the mold after formation.

In addition, in the cylindrical health device after the treatment portion was formed, the adhesive layer was formed up to the end portions such that the treatment portion covered the adhesive layer, and the adhesive layer was not visible from the outside.

### 2. Evaluation of Cylindrical Health Device

### (1) Lightweight (Evaluation 1)

The overall weight of the obtained cylindrical health device was measured, and lightweight was evaluated according to the following criteria.

The obtained results are shown in Table 1.
Very good: 500 g or less
Good: 800 g or less
Fair: 1000 g or less
Bad: Above 1000 g

### (2) Compression Test 1 (Evaluation 2)

A compression test based on JIS K6767:1999 was performed on the central portion of the obtained cylindrical health device, and the weight load-bearing capacity was evaluated according to the following criteria. The obtained results are shown in Table 1.

Very good: In the compression test, no fracture or deformation occurred until a stress of 50 MPa per unit area (1 cm²) was reached.

Good: In the compression test, no fracture or deformation occurred until a stress of at least 45 MPa per unit area (1 cm²) was reached.

Fair: In the compression test, no fracture or deformation occurred until a stress of at least 40 MPa per unit area (1 cm²) was reached.

Bad: In the compression test, no fracture or deformation occurred until a stress of below 40 MPa per unit area (1 cm²) was reached.

### (3) Compression Test 2 (Evaluation 3)

A compression test based on JIS K6767:1999 was performed on the end portion of the obtained cylindrical health device, and the weight load-bearing capacity was evaluated according to the following criteria. The obtained results are shown in Table 1.

Very good: In the compression test, no fracture or deformation occurred until a stress of 40 MPa per unit area (1 cm²) was reached.

Good: In the compression test, no fracture or deformation occurred until a stress of at least 35 MPa per unit area (1 cm²) was reached.

Fair: In the compression test, no fracture or deformation occurred until a stress of at least 30 MPa per unit area (1 cm²) was reached.

Bad: In the compression test, no fracture or deformation occurred until a stress of below 30 MPa per unit area (1 cm²) was reached.

### (4) Durability (Evaluation 4)

A practitioner performed two hours of treatment per day for three months using the obtained cylindrical health device.

After three months, the durability (adhesion) of the cylindrical health device shown in FIG. 1 and the like was evaluated according to the following criteria. The obtained results are shown in Table 1.

Very good: Absolutely no peeling occurred between the cylindrical member and the treatment portion.

Good: Peeling was confirmed at one or two locations between the cylindrical member and the treatment portion, but the cylindrical health device could still be used.

Fair: Peeling was confirmed at many locations between the cylindrical member and the treatment portion, and the cylindrical health device was almost unusable.

Bad: The cylindrical member and the treatment portion was completely separated from each other, a large misalignment occurred during use, and the cylindrical health device was almost unusable.

### (5) Visual Attraction (Evaluation 5)

A plurality of training tools having approximately the same size as the obtained cylindrical health device were prepared and installed side by side on a pedestal, together with the obtained cylindrical health device.

20 male and female participants aged 10 to 50 selected the training tool or the cylindrical health device that the participants felt most visually attractive among the training tools or the cylindrical health device arranged on the pedestal, and the visual attraction of the cylindrical health device shown in FIG. 1 and the like was evaluated according to the following criteria. The obtained results are shown in Table 1.

Very good: 15 or more participants out of 20 participants selected the obtained cylindrical health device.

Good: 10 or more participants out of 20 participants selected the obtained cylindrical health device.

Fair: 5 or more participants out of 20 participants selected the obtained cylindrical health device.

Bad: The number of the participants who selected the obtained cylindrical health device was below 5 out of 20 participants.

### Example 2

In Example 2, a cylindrical health device was produced in the same manner as in Example 1, except that the same predetermined embossed patterns as in Example 1 were formed on the entire surface of the cylindrical member, namely, including the end portions, and a compression test and the like were performed for evaluation. The obtained results are shown in Table 1.

### Example 3

In Example 3, as shown in FIGS. 2A and 2B, a cylindrical health device was produced in the same manner as in Example 1, except that the second reinforcing members including four openings (opening ratio: 60%) were provided at both end portions of the cylindrical health device, and a compression test and the like were performed for evaluation. The obtained results are shown in Table 1.

### Example 4

In Example 4, a cylindrical health device was produced in the same manner as in Example 1, except that the thickness of the adhesive layer was set to 100 μm, and the weight load-bearing capacity, durability, or the like was evaluated. The obtained results are shown in Table 1.

### Example 5

In Example 5, a cylindrical health device was produced in the same manner as in Example 1, except that the thickness of the adhesive layer was set to 30 μm and the second reinforcing members including four openings (opening ratio: 60%) were provided at both end portions of the cylindrical health device, and the weight load-bearing capacity, durability, or the like was evaluated. The obtained results are shown in Table 1.

### Example 6

In Example 6, a cylindrical health device was produced in the same manner as in Example 1, except that the thickness of the adhesive layer was set to 30 μm and embossing was not applied to the surface of the cylindrical health device at all, and the weight load-bearing capacity, durability, or the like was evaluated. The obtained results are shown in Table 1.

### Comparative Example 1

In Comparative Example 1, a cylindrical health device was produced in the same manner as in Example 1, except that the cylindrical health device included a treatment portion of a single color (one type of foamed resin) and did not include the first reinforcing member, and embossing was not applied to the surface of the cylindrical health device at all, and the weight load-bearing capacity, durability, or the like was evaluated. The obtained results are shown in Table 1.

### Comparative Example 2

In Comparative Example 2, a cylindrical health device was produced in the same manner as in Example 1, except that the cylindrical health device included a treatment portion having a mixed-color pattern (two types of foamed resin), did not include the first reinforcing member, and included the second reinforcing member, and embossing was not applied to the surface of the cylindrical health device at all, and the weight load-bearing capacity, durability, or the like was evaluated. The obtained results are shown in Table 1.

TABLE 1

| | | | first | second | | | | | | |
|---|---|---|---|---|---|---|---|---|---|---|
| | treatment | adhesive | reinforcing | reinforcing | | Evaluation | Evaluation | Evaluation | Evaluation | Evaluation |
| | portion | layer | member | member | embossing | 1 | 2 | 3 | 4 | 5 |
| Example 1 | camouflage | 50 | provided | not | not applied | Very | Very | Very | Very | Very |
| | | | | provided | to end | good | good | good | good | good |
| | | | | | portions | | | | | |
| Example 2 | camouflage | 50 | provided | not | entirety | Very | Very | Good | Very | Very |
| | | | | provided | | good | good | | good | good |
| Example 3 | camouflage | 50 | provided | provided | entirety | Good | Very | Very | Very | Very |
| | | | | | | | good | good | good | good |
| Example 4 | camouflage | 100 | provided | not | not applied | Very | Very | Very | Very | Very |
| | | | | provided | to end | good | good | good | good | good |
| | | | | | portions | | | | | |
| Example 5 | camouflage | 30 | provided | provided | not applied | Good | Very | Very | Good | Very |
| | | | | | to end | | good | good | | good |
| | | | | | portions | | | | | |
| Example 6 | camouflage | 30 | provided | provided | not applied | Good | Very | Very | Good | Very |
| | | | | | to end | | good | good | | good |
| | | | | | portions | | | | | |
| Comparative | single | no | not | not | not applied | Very | Bad | Fair | Bad | Bad |
| Example 1 | color | stress | provided | provided | | good | | | | |
| Comparative | mixed | 50 | not | provided | not applied | Fair | Bad | Fair | Good | Fair |
| Example 2 | color | | provided | | | | | | | |

Evaluation 1: lightweight
Evaluation 2: Compression test 1 (central portion)
Evaluation 3: Compression test 2 (end portion)
Evaluation 4: Durability
Evaluation 5: Visual attraction

### INDUSTRIAL APPLICABILITY

As described above, according to the cylindrical health device of the invention, lightweight, good compression durability, usage durability, and the like were achieved by adopting a configuration in which the cylindrical health device was composed of at least the cylindrical member and the treatment portion including the adhesive layer and the foamed resin layer (plurality of irregularities) provided therearound.

Therefore, adhesions or tension in human fascia, muscles, or the like could be relieved by bringing the cylindrical health device into contact with the human body and applying stimulation using the body weight and rotation, thereby inducing recovery of the human fascia, muscles, or the like to a normal state.

In addition, according to the cylindrical health device of the invention, since the treatment portion had a camouflage pattern derived from the plurality of foamed resins, good visual attraction and a high customer attraction effect could be obtained.

Furthermore, the balance between lightweight and compression durability was further improved by forming the predetermined embossed patterns on the surface of the cylindrical member either entirely or excluding the end portions.

What is claimed is:

1. A cylindrical health device comprising, from an inside toward an outside:
at least a cylindrical member;
an adhesive layer; and
a treatment portion,
wherein the treatment portion is made of a foamed resin, and
a reinforcing member is provided at least at a central portion of the cylindrical member along a longitudinal direction.

2. The cylindrical health device according to claim 1,
wherein the reinforcing member has a plate shape and is provided with an opening.

3. The cylindrical health device according to claim 1,
wherein the reinforcing member is fixed to a fixing portion provided in the cylindrical member.

4. The cylindrical health device according to claim 1,
wherein embossed patterns are provided on a surface of the cylindrical member.

5. The cylindrical health device according to claim 4,
wherein a non-formed portion in which the embossed patterns are not formed is provided at a predetermined distance from an end portion of the cylindrical member along the longitudinal direction of the cylindrical member.

6. The cylindrical health device according to claim 1,
wherein the foamed resin of the treatment portion includes at least a foamed resin containing a first coloring agent, a foamed resin containing a second coloring agent having a hue different from a hue of the first coloring agent, and a foamed resin containing a third coloring agent having a hue different from the hues of the first coloring agent and the second coloring agent.

7. The cylindrical health device according to claim 1,
wherein when the reinforcing member including an opening and provided at the central portion is referred to as a first reinforcing member, a second reinforcing member including a plurality of openings is provided at both end portions or one end portion of the cylindrical member.

8. A method for manufacturing a cylindrical health device including, from an inside toward an outside, at least a cylindrical member, an adhesive layer, a treatment portion, and a reinforcing member, the method comprising the following steps (A) to (D):
(A) a step of preparing a first cylindrical member in which at least the reinforcing member is provided in advance or a second cylindrical member to which the reinforcing member is later fixed, the adhesive layer, and a sheet-shaped material for the treatment portion in a foamed state derived from a plurality of foamed resins;
(B) a step of forming the cylindrical health device by wrapping the sheet-shaped material for the treatment portion in a foamed state around the cylindrical member via the adhesive layer;
(C) a step of compression-molding the sheet-shaped material for the treatment portion by accommodating the cylindrical health device inside a mold and then heating and pressurizing the cylindrical health device; and
(D) a step of attaching the reinforcing member to the second cylindrical member when the second cylindrical member is used.
